(19) United States
(12) Patent Application Publication
(10) Pub. No.: US 2026/0343393 A1
(43) Pub. Date: Oct. 29, 2026

(54) METHOD AND APPARATUS FOR ROAMING

(71) Applicant: Telefonaktiebolaget LM Ericsson (pub), Stockholm (SE)

(72) Inventors: Lin Jin, Changning District, Shanghai (CN); Yunjie Lu, Changning District, Shanghai (CN); Xiaoming Li, Changning District, Shanghai (CN)

(21) Appl. No.: 19/121,481

(22) PCT Filed: Aug. 1, 2023
(86) PCT No.: PCT/CN2023/110597

§ 371 Date: Apr. 16, 2025

(30) Foreign Application Priority Data
Oct. 28, 2022 (WO) PCT/CN2022/128291

(51) Int. Cl. H04W 48/18; H04W 8/02

(52) U.S. Cl. CPC H04W 48/18; H04W 8/02

(57) ABSTRACT

Various embodiments of the present disclosure provide a method for roaming. The method which may be performed by a first network node comprises: obtaining information about a second network node. The information about the second network node includes a first parameter indicating whether the second network node supports roaming. If the first parameter indicates that the second network node supports roaming, the information about the second network node further indicates that the second network node supports roaming for terminal devices roaming from specific one or more networks or from any network. In accordance with an exemplary embodiment, the method further comprises: determining whether to select the second network node for a terminal device roaming from a first network, based at least in part on the information about the second network node.

### FIELD OF THE INVENTION

The present disclosure generally relates to communication networks, and more specifically, to a method and apparatus for roaming.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE)/fourth generation (4G) network and new radio (NR)/fifth generation (5G) network are expected to achieve high traffic capacity and energy efficiency. In order to meet the diverse requirements of new services across a wide variety of industries, the 3rd generation partnership project (3GPP) is developing various network function (NF) services for the communication system architecture (e.g., 5G system (5GS) architecture, etc.) and the policy and charging control framework. The service-based architecture (SBA) under development for the next generation network can restructure the core network control plane and divide it into multiple independent modules with decoupled functions that can be updated individually. The introduction of the service-based interface protocols and network-function repository function (NRF) may enable the function modules to be used flexibly. In the SBA, service discovery may be provided for individual network functions (NFs) by an NRF, so as to meet different service requirements. Considering the diversity of network capabilities and application scenarios, configuration and management of various network services with different quality of service (QoS) requirements may become more challenging.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Communication networks such as 5G/NR networks are supposed to support the wide range of performance requirements demanded by multiple access technologies, a variety of services and new device types. A terminal device such as user equipment (UE) may be provided with various services by a communication network via different network nodes and/or functional entity. For example, for a UE roaming from a home public land mobile network (HPLMN) to a visited public land mobile network (VPLMN), a NF such as an access and mobility management function (AMF) in the VPLMN may need to discover and select one or more NFs (e.g., a short message service function (SMSF), a visit-session management function (V-SMF), a visit-policy charging function (V-PCF), etc.) in the VPLMN for the roaming UE. However, some of the NFs may not support a roaming service or can only serve part of PLMNs. In this case, the selected NF may not be able to handle a service request for the roaming UE and thus the corresponding service may not be activated for the roaming UE successfully. Therefore, it may be desirable to implement NF discovery for roaming UEs in a more efficient way.

Various exemplary embodiments of the present disclosure propose a solution for roaming, which can enable a NF (e.g., an SMSF, a session management function (SMF), a policy charging function (PCF), etc.) instance to be registered with attribute information (e.g., smsfInfo, smfInfo, pcfInfo, etc.) indicating whether the NF instance supports a roaming scenario, so that a service required for a roaming terminal device may be activated successfully by selecting a proper NF instance supporting the roaming scenario for the terminal device.

According to a first aspect of the present disclosure, there is provided a method performed by a first network node (e.g., AMF, etc.). The method comprises: obtaining information about a second network node. The information about the second network node may include a first parameter indicating whether the second network node supports roaming. If the first parameter indicates that the second network node supports roaming, the information about the second network node may further indicate that the second network node supports roaming for terminal devices roaming from specific one or more networks or from any network. In accordance with an exemplary embodiment, the method further comprises: determining whether to select the second network node for a terminal device roaming from a first network, based at least in part on the information about the second network node.

In accordance with an exemplary embodiment, if the first parameter indicates that the second network node supports roaming, the information about the second network node may further include a second parameter indicating the specific one or more networks.

In accordance with an exemplary embodiment, if the first parameter indicates that the second network node supports roaming and the information about the second network node further indicates that the second network node supports roaming for terminal devices roaming from any network, the information about the second network node may not be required to include additional parameter related to any network.

In accordance with an exemplary embodiment, when the specific one or more networks indicated by the information about the second network node include the first network, the first network node may determine to select the second network node for the terminal device.

In accordance with an exemplary embodiment, the determination of whether to select the second network node for the terminal device may also be based on a priority and/or a load of the second network node.

In accordance with an exemplary embodiment, the first network node may obtain the information about the second network node by: transmitting a request for discovering a network function required for the terminal device towards a third network node; and receiving a response to the request from the third network node. In an embodiment, the response may include the information about the second network node which is capable of providing the network function required for the terminal device.

In accordance with an exemplary embodiment, the first network node may be configured to implement an AMF.

In accordance with an exemplary embodiment, the second network node may be configured to implement one or more of an SMSF, an SMF and a PCF.

In accordance with an exemplary embodiment, the third network node may be configured to implement an NRF.

According to a second aspect of the present disclosure, there is provided an apparatus which may be implemented as a first network node. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first network node. The apparatus may comprise an obtaining unit and a determining unit. In accordance with some exemplary embodiments, the obtaining unit may be operable to carry out at least the obtaining step of the method according to the first aspect of the present disclosure. The determining unit may be operable to carry out at least the determining step of the method according to the first aspect of the present disclosure.

According to a fifth aspect of the present disclosure, there is provided a method performed by a second network node (e.g., an SMSF, an SMF, a PCF, etc.). The method comprises: determining information about the second network node. The information about the second network node may include a first parameter indicating whether the second network node supports roaming. If the first parameter indicates that the second network node supports roaming, the information about the second network node may further indicate that the second network node supports roaming for terminal devices roaming from specific one or more networks or from any network. In accordance with an exemplary embodiment, the method further comprises: transmitting a message including the information about the second network node towards a third network node (e.g., an NRF, etc.).

In accordance with an exemplary embodiment, the information about the second network node according to the fifth aspect of the present disclosure may correspond to the information about the second network node according to the first aspect of the present disclosure. Thus, the information about the second network node according to the first and fifth aspects of the present disclosure may have the same or similar contents and/or feature elements.

In accordance with an exemplary embodiment, the message including the information about the second network node may be a request for registering a network function provided by the second network node to the third network node.

According to a sixth aspect of the present disclosure, there is provided an apparatus which may be implemented as a second network node. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second network node. The apparatus may comprise a determining unit and a transmitting unit. In accordance with some exemplary embodiments, the determining unit may be operable to carry out at least the determining step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a third network node (e.g., an NRF, etc.). The method comprises: receiving a message including information about a second network node (e.g., an SMSF, an SMF, a PCF, etc.) from the second network node. The information about the second network node may include a first parameter indicating whether the second network node supports roaming. If the first parameter indicates that the second network node supports roaming, the information about the second network node may further indicate that the second network node supports roaming for terminal devices roaming from specific one or more networks or from any network. In accordance with an exemplary embodiment, the method further comprises: obtaining the information about the second network node from the message.

In accordance with an exemplary embodiment, the information about the second network node according to the ninth aspect of the present disclosure may correspond to the information about the second network node according to the first aspect of the present disclosure. Thus, the information about the second network node according to the first and ninth aspects of the present disclosure may have the same or similar contents and/or feature elements.

In accordance with an exemplary embodiment, the message including the information about the second network node may be a request for registering a network function provided by the second network node to the third network node.

In accordance with an exemplary embodiment, the method according to the ninth aspect of the present disclosure may further comprise: receiving a request for discovering a network function required for a terminal device from a first network node (e.g., an AMF, etc.).

In accordance with an exemplary embodiment, the method according to the ninth aspect of the present disclosure may further comprise: transmitting a response to the request towards the first network node. In an embodiment, the response may include the information about the second network node which is capable of providing the network function required for the terminal device.

According to a tenth aspect of the present disclosure, there is provided an apparatus which may be implemented as a third network node. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a third network node. The apparatus may comprise a receiving unit and an obtaining unit. In accordance with some exemplary embodiments, the receiving unit may be operable to carry out at least the receiving step of the method according to the ninth aspect of the present disclosure. The obtaining unit may be operable to carry out at least the obtaining step of the method according to the ninth aspect of the present disclosure.

According to various exemplary embodiments, a first network node such as an AMF can obtain, e.g., from a third network node such as an NRF, attribute information of a second network node (e.g., an SMSF, an SMF, a PCF, etc.) indicating whether the second network node can support a roaming scenario, so that the first network node may be able to determine whether to select the second network node for a roaming terminal device, e.g., according to the attribute information of the second network node. This can enhance the flexibility of NF deployment and the efficiency of NF discovery for different communication scenarios (e.g., a roaming scenario, a non-roaming scenario, etc.).

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary roaming architectures according to some embodiments of the present disclosure;

FIGS. 2A-2B are diagrams illustrating exemplary NF registration and discovery procedures according to some embodiments of the present disclosure;

FIG. 3 is a flowchart illustrating a method according to an embodiment of the present disclosure;

FIG. 4 is a flowchart illustrating another method according to an embodiment of the present disclosure;

FIG. 5 is a flowchart illustrating yet another method according to an embodiment of the present disclosure;

FIG. 6 is a block diagram illustrating an apparatus according to an embodiment of the present disclosure; and

FIG. 7A-7C are block diagrams illustrating various apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g., refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

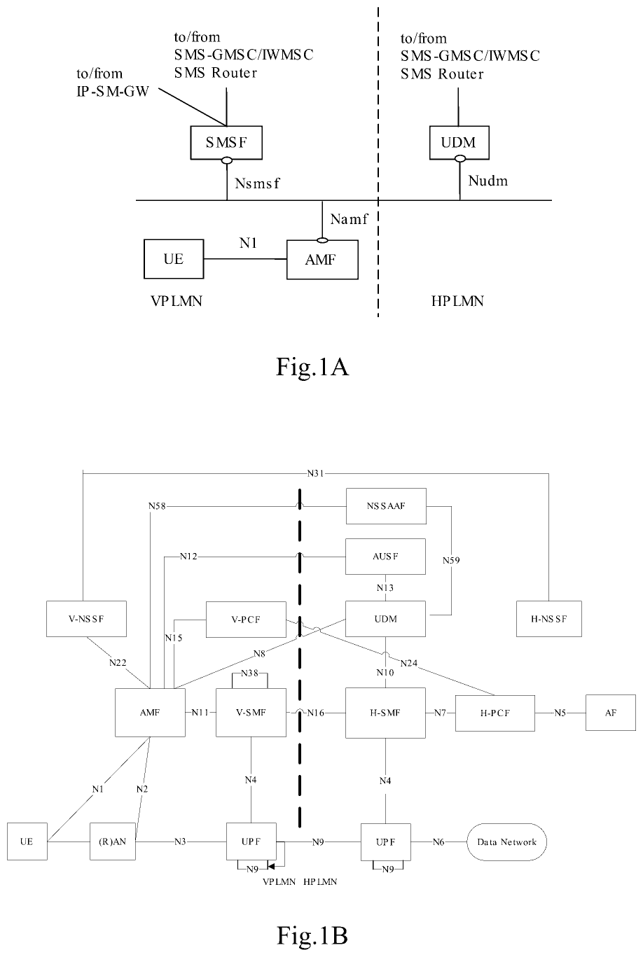

FIGS. 1A-1B are diagrams illustrating exemplary roaming architectures according to some embodiments of the present disclosure. The roaming architectures shown in FIG. 1A and FIG. 1B may correspond to those defined in 3GPP technical specification (TS) 23.501 V17.6.0. Specifically, a roaming architecture for short message service (SMS) over non-access stratum (NAS) shown in FIG. 1A may correspond to FIG. 4.4.2.1-3 in chapter 4.4.2 of 3GPP TS 23.501 V17.6.0, and a roaming 5G system architecture for a home routed scenario in reference point representation shown in FIG. 1B may correspond to FIG. 4.2.4-6 in chapter 4.2.4 of 3GPP TS 23.501 V17.6.0.

As defined in 3GPP, the roaming support may require a NF in a serving PLMN (VPLMN) to discover and select the corresponding NFs (e.g., a unified data management (UDM), an authentication server function (AUSF), etc.) in a HPLMN, and transport the service-based interface (SBI) message via the security edge protection proxy (SEPP) or via service communication proxy (SCP)/SEPP to the NFs in the HPLMN. Therefore, besides AMF, other NFs such as V-SMF, V-PCF (for UE policy) and SMSF may need to have the function(s) to support a roaming scenario.

The discovery of NFs (e.g., a home-session management function (H-SMF) and a home-policy charging function (H-PCF), etc.) in the HPLMN communicated with a V-PCF and a V-SMF may be performed by the AMF and the requested NF instance may be indicated in a request to the V-PCF and the V-SMF. Similarly, the AMF may also need to find an SMSF which can serve the HPLMN. Thus, it may be required for the V-PCF, the V-SMF and the SMSF to support a roaming scenario.

Currently, the AMF may not know whether the corresponding peer NFs (e.g., SMSF, V-PCF or V-SMF) discovered can serve an inbound roamer or not based on the current information of NFDiscovery from the NRF. Therefore, the AMF may select an incorrect NF (i.e., not supporting the roaming scenario) to handle a service request for the inbound roamer, then the corresponding service may fail because the selected peer NF may not be able to serve the inbound roamer of the specific PLMN.

For example, in the case where the AMF may need to discover and select an SMSF instance in a registration procedure of SMS over NAS, if there are multiple SMSF instances deployed in the network and one of them is only used to serve the non-roaming subscribers, then it may be possible for the AMF to select a non-roaming SMSF instance to activate an SMS over NAS service for a roaming subscriber. This may cause a failure of the activation of SMS over NAS, because the SMSF instance may not implement the corresponding updates for the roaming support. This problem may also exist when the SMSF instance only supports part of PLMNs which have roaming agreement with the serving PLMN (VPLMN).

In order to address one or more issues mentioned above, various exemplary embodiments of the present disclosure propose solutions to enhance NF register and discovery for roaming. In accordance with an exemplary embodiment, one or more of the following parameters or attributes may be introduced when a NF instance (also called NF in this document) performs the registration towards an NRF:
Roaming support indicator, which may indicate whether the NF instance is supporting the roaming or not.
   In an embodiment, the default value of the roaming support indicator may be “false”, and the value may be only updated to “true” when the roaming scenario is supported by the NF instance.
Serving HPLMN list, which may include a list of HPLMNs that the NF instance can serve, e.g., when the roaming support indicator is set to “true”.
   In an embodiment, if the serving HPLMN list is empty, then it means that the NF instance can only serve the UE of serving PLMN(s) where the NF instance locates.
   In another embodiment, if the serving HPLMN list is absent, it means that the NF instance can serve all PLMNs with roaming agreement.

In accordance with an exemplary embodiment, the parameters or attributes as mentioned above may be introduced into a profile of a NF instance (e.g., an SMSF, an SMF, a PCF, etc.) to indicate roaming related capability of the NF instance. Table 1 shows an exemplary NFProfile of the NF instance, where smsfInfo, smfInfo and/or pcfInfo are newly added attributes based on the type of NFProfile as described in chapter 6.1.6.2.2 of 3GPP TS 29.510 V17.6.0.

TABLE 1

| Attribute | | | | |
|---|---|---|---|---|
| name | Data type | P | Cardinality | Description |
| nfInstanceId | NfInstanceId | M | 1 | Unique identity of |
| | | | | the NF Instance. |
| nfType | NFType | M | 1 | Type of Network |
| | | | | Function. |
| nfStatus | NFStatus | M | 1 | Status of the NF |
| | | | | Instance. |
| . . . | . . . | . . . | . . . | . . . |
| mnpfInfo | MnpfInfo | O | 0 . . . 1 | Specific data for |
| | | | | the MNPF. |
| smsfInfo | SmsfInfo | O | 0 . . . 1 | Specific data for |
| | | | | the SMSF. |
| smfInfo | SmfInfo | O | 0 . . . 1 | Specific data for |
| | | | | the SMF. |
| pcfInfo | PcfInfo | O | 0 . . . 1 | Specific data for |
| | | | | the PCF. |

In accordance with exemplary embodiments, Table 2 shows exemplary information elements (IEs) for the type of SmsfInfo, Table 3 shows exemplary IEs for the type of SmfInfo, and Table 4 shows exemplary IEs for the type of PcfInfo.

TABLE 2

| Attribute | | | | |
|---|---|---|---|---|
| name | Data type | P | Cardinality | Description |
| roamingUeInd | boolean | O | 0 . . . N | When present, this IE may indicate |
| | | | | whether the SMSF can serve roaming UEs: |
| | | | | true: the SMSF can support roaming UEs. |
| | | | | false: the SMSF may not support roaming |
| | | | | UEs. |
| | | | | Absence of this IE may indicate that it is |
| | | | | not specified whether the SMSF can serve |
| | | | | roaming UEs. |
| remotePlmnList | array(PlmnId) | O | 1 . . . N | This IE may be present, e.g., when the |
| | | | | roamingUeInd IE is present with the value |
| | | | | “true”. |
| | | | | When present, this IE may indicate a list of |
| | | | | remote PLMNs served by the SMSF, i.e., |
| | | | | the SMSF can serve the roaming UEs |
| | | | | belong to the indicated remote PLMNs. |
| | | | | If the roamingUeInd IE is present with the |
| | | | | value “true”, absence of the |
| | | | | remotePImnList IE may indicate that the |
| | | | | SMSF can serve roaming UEs from any |
| | | | | remote PLMN. |

TABLE 3

| Attribute name | Data type | P | Cardinality | Description |
|---|---|---|---|---|
| sNssaiSmfInfoList | array(SnssaiS | M | 1 . . . N | List of parameters supported by the SMF |
| | mfInfoItem) | | | per S-NSSAI. |
| . . . | . . . | . . . | . . . | . . . |
| vsmfSupportInd | boolean | O | 0 . . . 1 | This IE may be used by an SMF to |
| | | | | explicitly indicate the support of V-SMF |
| | | | | capability and its preference to be selected |
| | | | | as V-SMF. |
| | | | | When present, this IE may indicate |
| | | | | whether the V-SMF capability are |
| | | | | supported by the SMF: |
| | | | | true: V-SMF capability supported by the |
| | | | | SMF |
| | | | | false: V-SMF capability not supported by |
| | | | | the SMF. |
| | | | | Absence of this IE may indicate that the V- |
| | | | | SMF capability support of the SMF is not |
| | | | | specified. |
| . . . | . . . | . . . | . . . | . . . |
| remotePlmnList | array(PlmnId) | O | 1 . . . N | This IE may be present, e.g., when the |
| | | | | vsmfSupportInd IE is present with the value |
| | | | | “true”. |
| | | | | When present, this IE may indicate a list of |
| | | | | remote PLMNs served by the SMF, i.e., the |
| | | | | SMF can serve the roaming UEs belong to |
| | | | | the indicated remote PLMNs. |
| | | | | If the vsmfSupportInd IE is present with the |
| | | | | value “true”, absence of the |
| | | | | remotePImnList IE may indicate that the |
| | | | | SMF can serve roaming UEs from any |
| | | | | remote PLMN. |

TABLE 4

| Attribute name | Data type | P | Cardinality | Description |
|---|---|---|---|---|
| groupId | NfGroupId | O | 0 . . . 1 | Identity of the PCF group that is served by |
| | | | | the PCF instance. |
| | | | | If not provided, the PCF instance does not |
| | | | | pertain to any PCF group. |
| . . . | . . . | . . . | . . . | . . . |
| v2xCapability | V2xCapability | C | 0 . . . 1 | This IE may be present if the PCF supports |
| | | | | V2X Capability. |
| | | | | When present, this IE may indicate the |
| | | | | supported V2X Capability by the PCF. |
| roamingUeInd | boolean | O | 0 . . . N | When present, this IE may indicate |
| | | | | whether the PCF can serve roaming UEs: |
| | | | | true: the PCF can support roaming UEs. |
| | | | | false: the PCF may not support roaming |
| | | | | UEs. |
| | | | | Absence of this IE may indicate that it is |
| | | | | not specified whether the PCF can serve |
| | | | | roaming UEs. |
| remotePlmnList | array(PlmnId) | O | 1 . . . N | This IE may be present, e.g., when the |
| | | | | roamingUeInd IE is present with the value |
| | | | | “true”. |
| | | | | When present, this IE may indicate a list of |
| | | | | remote PLMNs served by the PCF, i.e., the |
| | | | | PCF can serve the roaming UEs belong to |
| | | | | the indicated remote PLMNs. |
| | | | | If the roamingUeInd IE is present with the |
| | | | | value “true”, absence of the |
| | | | | remotePImnList IE may indicate that the |
| | | | | PCF can serve roaming UEs from any |
| | | | | remote PLMN. |

It is noted that since the vsmfSupportInd IE in the type of SmfInfo may be used to indicate that the SMF may be acting as a V-SMF to serve the inbound roamer, the vsmfSupportInd IE may implicitly indicate that the roaming is supported by the SMF.

In accordance with an exemplary embodiment, based on one or more IEs (e.g., roamingUeInd, remotePlmnList, vsmfSupportInd, etc.) of the new attribute such as smsfInfo/smftnfo/pcfInfo, the AMF can select the correct NF(s) such as SMSF, V-SMF and V-PCF for the inbound roaming subscriber of the specific PLMN.

Many advantages may be achieved by applying the proposed solutions. For example, with the information returned from the NFProfile of SMSF/V-SMF/V-PCF instance, it may be possible for the AMF to find the correct NF instance(s) for the inbound roamer to support the corresponding functionality, e.g., SMS over NAS service, PDU session establishment and continuity, especially when one of the corresponding NFs (SMSF/V-SMF/V-PCF) instance does not support the inbound roamer. In addition, the network operator may have the flexible NF deployment including the roaming and non-roaming scenarios for NFs such as SMSF, V-SMF and V-PCF. For example, the flexible NF deployment may enable some NF instances (e.g., one SMSF instance, etc.) dedicated for the roaming subscriber, and other NF instances (e.g., other SMSF instance(s), etc.) for the home subscriber.

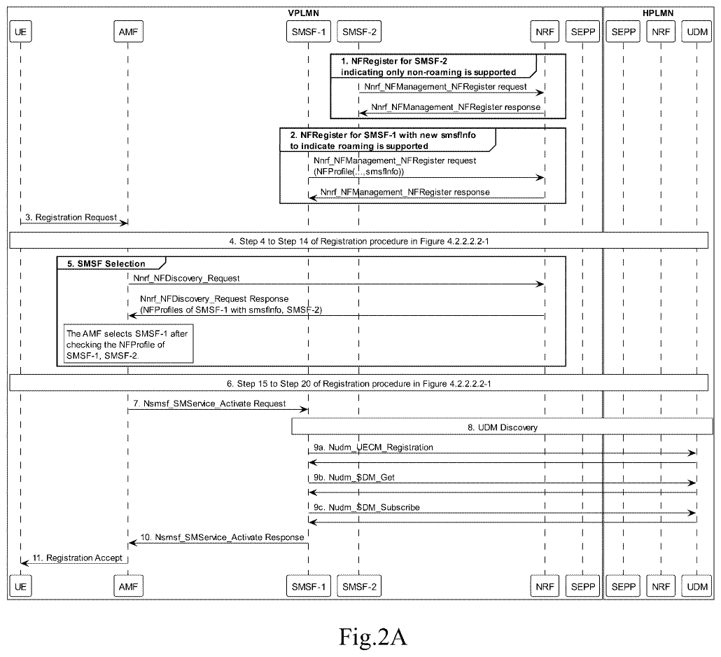

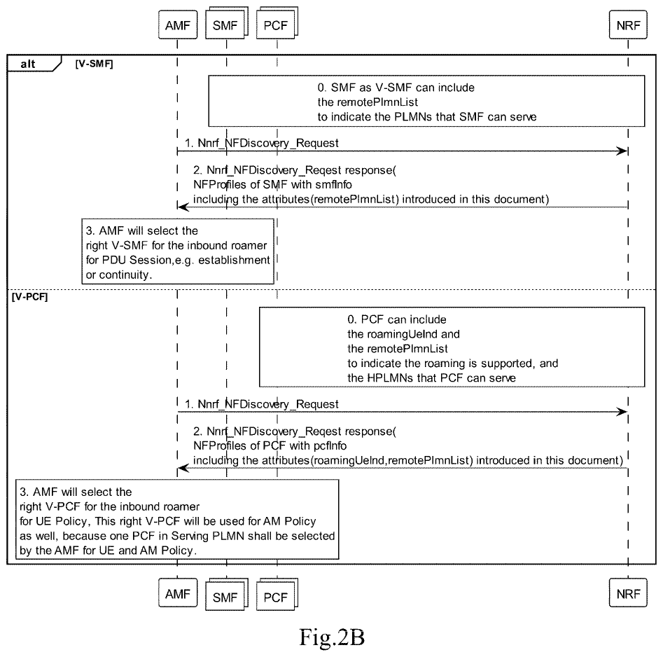

FIGS. 2A-2B are diagrams illustrating exemplary NF registration and discovery procedures according to some embodiments of the present disclosure. It can be appreciated that the NF registration and discovery procedures shown in FIGS. 2A-2B are mainly described with respect to roaming related capability, and other steps and operations are omitted in order not to obscure the concepts presented herein. The detailed description of the NF registration and discovery procedures may refer to the chapter 4.13.3.1 of 3GPP TS 23.502 V17.6.0.

FIG. 2A shows a use case related to an SMSF for SMS over NAS functionality. As shown in FIG. 2A, the NF registration and discovery procedure for this use case may include the following steps:
1. An SMSF-2 instance may perform the NFRegister to an NRF, e.g., by sending a Nnrf_NFManagement_NFRegister request which may indicate that non-roaming is supported by the SMSF-2 instance. According to exemplary embodiments, there may be three alternatives for the Nnrf_NFManagement_NFRegister request: (i) without the new attribute smsfInfo, or (ii) with the new attribute smsfInfo including an empty list as the value of remotePlmnList, or (iii) with the new attribute smsfInfo including an indicator (e.g., roamingUeInd, etc.) which may indicate that the SMSF-2 instance does not support roaming.
2. An SMSF-1 instance may perform the NFRegister to the NRF, e.g., by sending a Nnrf_NFManagement_NFRegister request including the new attribute smsfInfo in the NFProfile. This may indicate that roaming is supported by the SMSF-1 instance.
3. A UE may send to an AMF, a registration request which includes an “SMS supported” indication indicating the UE's capability for SMS over NAS transport.
4. The registration procedure for the UE may be performed, e.g., by performing step 4 to step 14 of the registration procedure as illustrated in FIG. 4.2.2.2.2-1 of 3GPP TS 23.502 V17.6.0.
5. If the “SMS supported” indication is included in the registration request, the AMF may check the SMS subscription data that the SMS service is allowed to the UE. If the SMS service is allowed, then the AMF may perform SMSF selection by sending a NFDiscovery request towards the NRF. In this case, the NRF may return the NFProfiles of SMSF-1 and SMSF-2 to the AMF. Based on the attribute smsfInfo in the NFProfile of SMSF-1, the AMF may select the SMSF-1 instance to activate the SMS over NAS service, because the SMSF-1 instance can serve this inbound roamer while the SMSF-2 instance does not support roaming. In an embodiment, when there are multiple SMSF instances returned from the NRF to indicate, e.g., via the smsfInfo attribute, that more than one SMSF instance can serve the inbound roamer, the AMF may select one of the SMSF instances according to the priority, the load, and/or other factors.
6-11. The detailed description of steps 6-11 shown in FIG. 2A may refer to steps 4-9 of FIG. 4.13.3.1-1 in chapter 4.13.3.1 of 3GPP TS 23.502 V17.6.0.

It can be appreciated that the NFProfiles with/without the attribute smsfInfo to indicate the NF capability of supporting roaming shown in FIG. 2A are just examples and there may be various suitable options to implement such capability indication. For example, there may be the following options:
No attribute smsfInfo is configured, and this may be used to implement backward compatibility of the already deployed SMSF.
New attribute smsfInfo may be configured for a new version of SMSF which can support configuration of roaming capability indication, and the value of remotePlmnList included in the smsfInfo may have the following three different alternatives:
   Undefined (e.g., no value), which means that all UEs roaming from any HPLMN are supported;
   A list of HPLMN, which means that only the UEs roaming from the HPLMN(s) in this list are supported; and
   An empty list, which means that there is no UE roaming from any HPLMN is supported, i.e., the same result as without smsfInfo and the roaming scenario may not be supported.

FIG. 2B shows use cases for V-SMF and V-PCF similar to the use case for SMSF shown in FIG. 2A. For the case of V-SMF, an SMF may register to an NRF, e.g., by including the attribute remotePlmnList in an NFRegister request to indicate a list of PLMNs that the SMF can serve. As shown in FIG. 2B, in response to an NFDiscovery request from an AMF, the NRF may return the NFProfile of the SMF with smfInfo including the attribute remotePlmnList to the AMF. Based on the corresponding information included in the response of NFDiscovery request, the AMF may perform the selection of V-SMF for the inbound roamer for PDU session, e.g., establishment or continuity. Similarly, for the case of V-PCF, a PCF may register to the NRF, e.g., by including the attribute roamingUeInd and/or the attribute remotePlmnList in an NFRegister request to indicate that the roaming is supported by the PCF and/or a list of PLMNs that the PCF can serve. As shown in FIG. 2B, in response to an NFDiscovery request from the AMF, the NRF may return the NFProfile of the PCF with pcfInfo including the attribute roamingUeInd and/or the attribute remotePlmnList to the AMF. Based on the corresponding information included in the response of NFDiscovery request, the AMF may select a proper V-PCF for the inbound roamer for UE policy. In an embodiment, the selected V-PCF may be used for access and mobility management (AM) policy as well.

It can be appreciated that network elements and signaling messages shown in FIG. 2A and FIG. 2B are just as examples, and more or less alternative network elements and signaling messages may be involved in the NF register and discovery procedure according to various embodiments of the present disclosure.

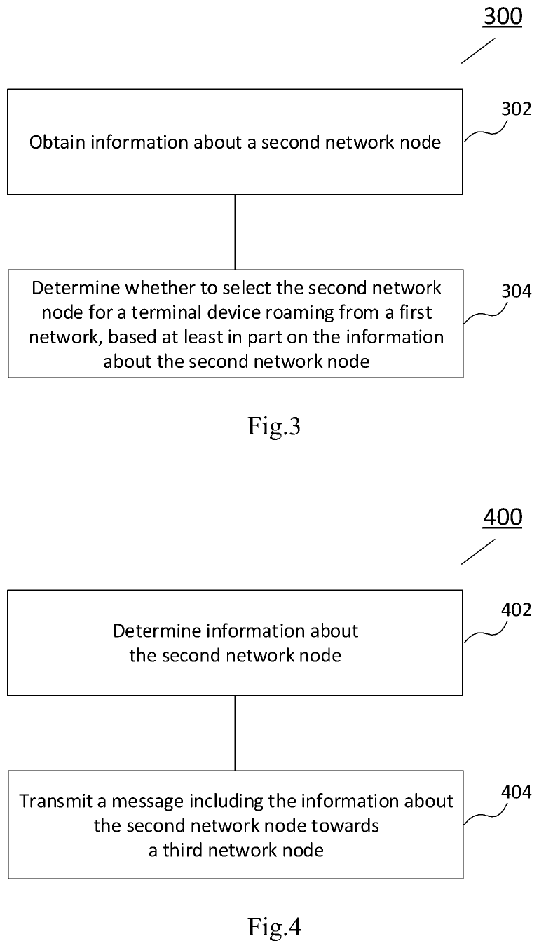

FIG. 3 is a flowchart illustrating a method 300 according to some embodiments of the present disclosure. The method 300 illustrated in FIG. 3 may be performed by a first network node (e.g., AMF, etc.) or an apparatus communicatively coupled to the first network node. In accordance with an exemplary embodiment, the first network node may be configured to discover and select a NF (e.g., an SMSF, an SMF, a PCF, etc.) for a terminal device (e.g., a UE, etc.) roaming from a first network (e.g., a HPLMN, etc.) to a second network (e.g., a VPLMN, etc.). In accordance with another exemplary embodiment, the first network node may be configured to implement an AMF or act as any other suitable network entity which may be configured to perform access and mobility management for the terminal device.

According to the exemplary method 300 illustrated in FIG. 3, the first network node may obtain information about a second network node (e.g., an SMSF, an SMF, a PCF, etc.), as shown in block 302. The information about the second network node may include a first parameter (e.g., roamingUeInd in Table 2, vsmfSupportInd in Table 3, and roamingUeInd in Table 4, etc.) indicating whether the second network node supports roaming. If the first parameter indicates that the second network node supports roaming, the information about the second network node may further indicate that the second network node supports roaming for terminal devices roaming from specific one or more networks or from any network. In an embodiment, the information about the second network node may comprise smsfInfo, smfInfo and/or pcfInfo as described with respect to Tables 1-4 and FIGS. 2A-2B, and optionally be included in a profile and/or registration information of the second network node. When the second network node supports roaming, the information about the second network node may indicate one or multiple networks (e.g., PLMNs, etc.) from which a roaming service may be supported by the second network node. In accordance with an exemplary embodiment, the first network node may determine whether to select the second network node for a terminal device roaming from a first network, based at least in part on the information about the second network node, as shown in block 304.

In accordance with an exemplary embodiment, if the first parameter indicates that the second network node supports roaming, the information about the second network node may further include a second parameter (e.g., remotePlmnList as described with respect to Tables 2-4, etc.) indicating the specific one or more networks. In accordance with another exemplary embodiment, if the first parameter indicates that the second network node supports roaming and the information about the second network node further indicates that the second network node supports roaming for terminal devices roaming from any network, the information about the second network node may not be required to include additional parameter related to any network.

In accordance with an exemplary embodiment, the information about the second network node may indicate one or multiple networks from which a roaming service may be supported by the second network node, via a parameter (e.g., remotePlmnList, etc.) in one or more of the following ways:
when the parameter is present in the information about the second network node, the one or multiple networks are a list of networks indicated by the parameter; and
when the parameter is absent in the information about the second network node, the one or multiple networks are all networks with roaming agreement (e.g., all PLMNs having roaming agreement with the serving PLMN of the roaming terminal device, etc.).

In accordance with an exemplary embodiment, when the second network node does not support roaming, the information about the second network node may include an empty list to indicate that there is no network from which the roaming service is supported by the second network node.

In accordance with an exemplary embodiment, when the specific one or more networks indicated by the information about the second network node include the first network, the first network node may determine to select the second network node for the terminal device.

In accordance with an exemplary embodiment, the determination of whether to select the second network node for the terminal device may be performed by the first network node also based on a priority and/or a load of the second network node.

In accordance with an exemplary embodiment, the first network node may obtain the information about the second network node by: transmitting a request (e.g., a Nnrf_NFDiscovery_Request, etc.) for discovering a network function required for the terminal device towards a third network node (e.g., an NRF, etc.); and receiving a response (e.g., a Nnrf_NFDiscovery_Request Response, etc.) to the request from the third network node. In an embodiment, the response may include the information about the second network node which is capable of providing the network function required for the terminal device.

In accordance with an exemplary embodiment, the first network node may be configured to implement an AMF. In accordance with another exemplary embodiment, the second network node may be configured to implement one or more of an SMSF, an SMF and a PCF. In accordance with a further exemplary embodiment, the third network node may be configured to implement an NRF.

FIG. 4 is a flowchart illustrating a method 400 according to some embodiments of the present disclosure. The method 400 illustrated in FIG. 4 may be performed by a second network node or an apparatus communicatively coupled to the second network node. In accordance with an exemplary embodiment, the second network node may be configured to implement one or more NFs such as SMSF, SMF and/or PCF.

According to the exemplary method 400 illustrated in FIG. 4, the second network node may determine information (e.g., smsfInfo, smfInfo, pcfInfo, etc.) about the second network node, as shown in block 402. The information about the second network node may include a first parameter (e.g., roamingUeInd in Table 2, vsmfSupportInd in Table 3, and roamingUeInd in Table 4, etc.) indicating whether the second network node supports roaming. If the first parameter indicates that the second network node supports roaming, the information about the second network node may further indicate that the second network node supports roaming for terminal devices roaming from specific one or more networks or from any network. In accordance with an exemplary embodiment, the second network node may transmit a message including the information about the second network node towards a third network node (e.g., an NRF, etc.), as shown in block 404.

In accordance with an exemplary embodiment, the information about the second network node according to the method 400 may correspond to the information about the second network node according to the method 300. Thus, the information about the second network node as described with respect to FIG. 3 and FIG. 4 may have the same or similar contents and/or feature elements.

In accordance with an exemplary embodiment, the message including the information about the second network node may be a request (e.g., a Nnrf_NFManagement_NFRegister request, etc.) for registering a network function provided by the second network node to the third network node. Optionally, the second network node may receive a response (e.g., a Nnrf_NFManagement_NFRegister response, etc.) to the request from the third network node.

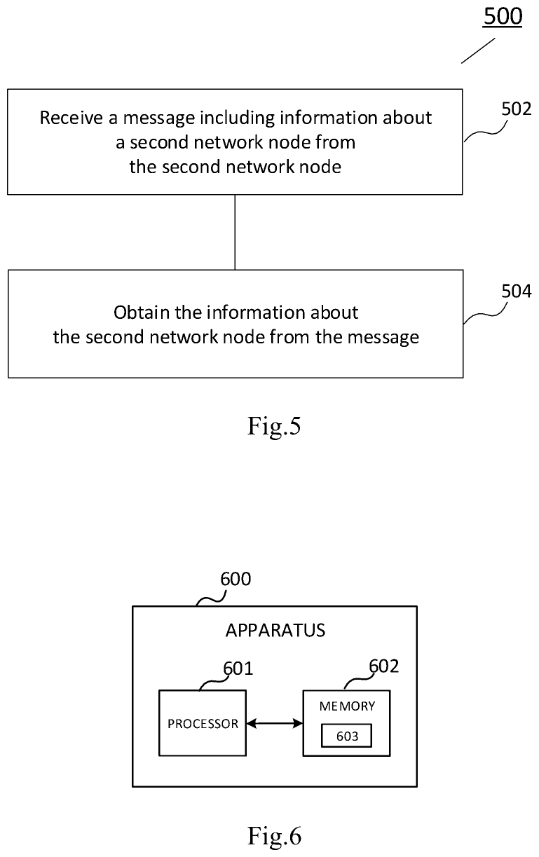

FIG. 5 is a flowchart illustrating a method 500 according to some embodiments of the present disclosure. The method 500 illustrated in FIG. 5 may be performed by a third network node or an apparatus communicatively coupled to the third network node. In accordance with an exemplary embodiment, the third network node may be configured to store profiles of one or more NFs (e.g., SMSF, SMF, PCF, etc.). In accordance with another exemplary embodiment, the third network node may be configured to implement an NRF or act as any other suitable network entity which may be configured to assist in NF register and discovery.

According to the exemplary method 500 illustrated in FIG. 5, the third network node may receive a message including information (e.g., smsfInfo, smfInfo, pcfInfo, etc.) about a second network node (e.g., the second network node as described with respect to FIG. 3 and FIG. 4) from the second network node, as shown in block 502. The information about the second network node may include a first parameter (e.g., roamingUeInd in Table 2, vsmfSupportInd in Table 3, and roamingUeInd in Table 4, etc.) indicating whether the second network node supports roaming. If the first parameter indicates that the second network node supports roaming, the information about the second network node may further indicate that the second network node supports roaming for terminal devices roaming from specific one or more networks or from any network. In accordance with an exemplary embodiment, the third network node may obtain the information about the second network node from the message, as shown in block 504.

In accordance with an exemplary embodiment, the information about the second network node according to the method 500 may correspond to the information about the second network node according to the method 300. Thus, the information about the second network node as described with respect to FIG. 3 and FIG. 5 may have the same or similar contents and/or feature elements.

In accordance with an exemplary embodiment, the message including the information about the second network node may be a request (e.g., a Nnrf_NFManagement_NFRegister request, etc.) for registering a network function provided by the second network node to the third network node. Optionally, the third network node may transmit a response (e.g., a Nnrf_NFManagement_NFRegister response, etc.) to the request towards the second network node.

In accordance with an exemplary embodiment, the third network node may receive a request (e.g., a Nnrf_NFDiscovery_Request, etc.) for discovering a network function required for a terminal device from a first network node (e.g., the first network node as described with respect to FIG. 3). In accordance with another exemplary embodiment, the third network node may transmit a response (e.g., a Nnrf_NFDiscovery_Request Response, etc.) to the request towards the first network node. In an embodiment, the response may include the information about the second network node which is capable of providing the network function required for the terminal device. As described with respect to FIG. 3, the information about the second network node may be used by the first network node to determine whether to select the second network node to serve the roaming terminal device.

The various blocks shown in FIGS. 3-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

It can be appreciated that the network node according to various embodiments can be implemented either as a network element and/or a network entity on a dedicated hardware, as a software instance running on a dedicated hardware, or as a virtualized function instantiated on an appropriate platform, e.g., on a cloud infrastructure.

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a first network node as described with respect to FIG. 3, or a second network node as described with respect to FIG. 4, or a third network node as described with respect to FIG. 5. In such cases, the apparatus 600 may be implemented as a first network node as described with respect to FIG. 3, or a second network node as described with respect to FIG. 4, or a third network node as described with respect to FIG. 5.

In some implementations, the one or more memories 602 and the computer program codes 603 may be configured to, with the one or more processors 601, cause the apparatus 600 at least to perform any operation of the method as described in connection with FIG. 3. In other implementations, the one or more memories 602 and the computer program codes 603 may be configured to, with the one or more processors 601, cause the apparatus 600 at least to perform any operation of the method as described in connection with FIG. 4. In other implementations, the one or more memories 602 and the computer program codes 603 may be configured to, with the one or more processors 601, cause the apparatus 600 at least to perform any operation of the method as described in connection with FIG. 5. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

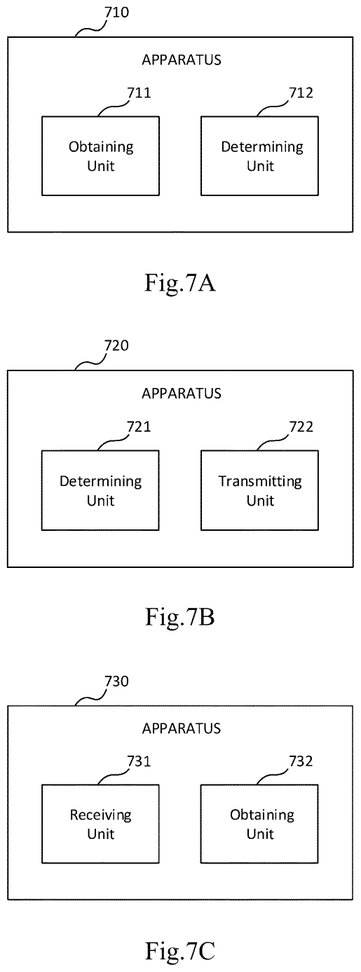

FIG. 7A is a block diagram illustrating an apparatus 710 according to some embodiments of the present disclosure. As shown in FIG. 7A, the apparatus 710 may comprise an obtaining unit 711 and a determining unit 712. In an exemplary embodiment, the apparatus 710 may be implemented in a first network node (e.g., an AMF, etc.). The obtaining unit 711 may be operable to carry out the operation in block 302, and the determining unit 712 may be operable to carry out the operation in block 304. Optionally, the obtaining unit 711 and/or the determining unit 712 may be operable to carry out more or less operations to implement the proposed methods according to the exemplary embodiments of the present disclosure.

FIG. 7B is a block diagram illustrating an apparatus 720 according to some embodiments of the present disclosure. As shown in FIG. 7B, the apparatus 720 may comprise a determining unit 721 and a transmitting unit 722. In an exemplary embodiment, the apparatus 720 may be implemented in a second network node (e.g., an SMSF, an SMF, a PCF, etc.). The determining unit 721 may be operable to carry out the operation in block 402, and the transmitting unit 722 may be operable to carry out the operation in block 404. Optionally, the determining unit 721 and/or the transmitting unit 722 may be operable to carry out more or less operations to implement the proposed methods according to the exemplary embodiments of the present disclosure.

FIG. 7C is a block diagram illustrating an apparatus 730 according to some embodiments of the present disclosure. As shown in FIG. 7C, the apparatus 730 may comprise a receiving unit 731 and an obtaining unit 732. In an exemplary embodiment, the apparatus 730 may be implemented in a third network node (e.g., an NRF, etc.). The receiving unit 731 may be operable to carry out the operation in block 502, and the obtaining unit 732 may be operable to carry out the operation in block 504. Optionally, the receiving unit 731 and/or the obtaining unit 732 may be operable to carry out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a first network node, comprising:
obtaining information about a second network node, wherein the information about the second network node includes a first parameter indicating whether the second network node supports roaming;
if the first parameter indicates that the second network node supports roaming, the information about the second network node further includes a second parameter indicating specific one or more remote networks that the second network node supports for terminal devices roaming from the specific one or more remote networks, or from any remote network by absence of the second parameter; and
determining whether to select the second network node for a terminal device roaming from a first network, based at least in part on the information about the second network node.

2. The method according to claim 1, wherein the first network includes a home public land mobile network of the terminal device.

3. (canceled)

4. The method according to claim 1, wherein if the first parameter indicates that the second network node supports roaming and the information about the second network node include the first network, the first network node determines to select the second network node for the terminal device.

5. The method according to claim 1, wherein the determination of whether to select the second network node for the terminal device is also based on a priority and/or a load of the second network node.

6. The method according to claim 1, wherein the first network node obtains the information about the second network node by performing the following operations:
transmitting a request for discovering a network function required for the terminal device towards a third network node; and
receiving a response to the request from the third network node, wherein the response includes the information about the second network node which is capable of providing the network function required for the terminal device.

7. The method according to claim 6, wherein the third network node is configured to implement a network-function repository function (NRF).

8. The method according to claim 1, wherein the first network node is configured to implement an access and mobility management function (AMF).

9. The method according to claim 1, wherein the second network node is configured to implement one or more of the following functions:
a short message service function (SMSF);
a session management function (SMF); and
a policy charging function (PCF).

10.-12. (canceled)

13. A method performed by a second network node, comprising:
determining information about the second network node, wherein the information about the second network node includes a first parameter indicating whether the second network node supports roaming, and if the first parameter indicates that the second network node supports roaming, the information about the second network node further includes a second parameter indicating specific one or more remote networks that the second network node supports terminal devices roaming from the specific one or more remote networks, or from any remote network by absence of the second parameter; and
transmitting a message including the information about the second network node towards a third network node.

14.-15. (canceled)

16. The method according to claim 13, wherein the message including the information about the second network node is a request for registering a network function provided by the second network node to the third network node.

17. The method according to claim 13, wherein the second network node is configured to implement one or more of the following functions:
a short message service function (SMSF);
a session management function (SMF); and
a policy charging function (PCF).

18. The method according to claim 13, wherein the third network node is configured to implement a network-function repository function (NRF).

19.-21. (canceled)

22. A method performed by a third network node, comprising:
receiving a message including information about a second network node from the second network node, wherein the information about the second network node includes a first parameter indicating whether the second network node supports roaming, and if the first parameter indicates that the second network node supports roaming, the information about the second network node further includes a second parameter indicating specific one or more remote networks that the second network node supports for terminal devices roaming from the specific one or more remote networks, or from any remote network by absence of the second parameter; and
obtaining the information about the second network node from the message.

23.-24. (canceled)

25. The method according to claim 22, wherein the message including the information about the second network node is a request for registering a network function provided by the second network node to the third network node.

26. The method according to claim 22, further comprising:
receiving a request for discovering a network function required for a terminal device from a first network node; and
transmitting a response to the request towards the first network node, wherein the response includes the information about the second network node which is capable of providing the network function required for the terminal device.

27. The method according to claim 26, wherein the first network node is configured to implement an access and mobility management function (AMF).

28. The method according to claim 22, wherein the second network node is configured to implement one or more of the following functions:
a short message service function (SMSF);
a session management function (SMF); and
a policy charging function (PCF).

29. The method according to claim 22, wherein the third network node is configured to implement a network-function repository function (NRF).

30.-32. (canceled)
